(19) United States
(12) Patent Application Publication
(10) Pub. No.: US 2019/0213480 A1
(43) Pub. Date: Jul. 11, 2019

(54) PERSONALIZED QUESTION-ANSWERING SYSTEM AND CLOUD SERVER FOR PRIVATE INFORMATION PROTECTION AND METHOD OF PROVIDING SHARED NEURAL MODEL THEREOF

(71) Applicant: Electronics and Telecommunications Research Institute, Daejeon (KR)

(72) Inventors: Joon Ho LIM, Daejeon (KR); Mi Ran CHOI, Daejeon (KR); Hyun Ki KIM, Daejeon (KR); Min Ho KIM, Daejeon (KR); Ji Hee RYU, Daejeon (KR); Kyung Man BAE, Daejeon (KR); Yong Jin BAE, Daejeon (KR); Ji Hyun WANG, Sejong-si (KR); Hyung Jik LEE, Daejeon (KR); Soo Jong LIM, Daejeon (KR); Myung Gil JANG, Daejeon (KR); Jeong HEO, Daejeon (KR)

(73) Assignee: Electronics and Telecommunications Research Institute, Daejeon (KR)

(21) Appl. No.: 16/245,468

(22) Filed: Jan. 11, 2019

(30) Foreign Application Priority Data
Jan. 11, 2018 (KR) 10-2018-0003643
Jun. 29, 2018 (KR) 10-2018-0075840

(51) Int. Cl. G06N 3/08; G06F 16/332; G06N 5/04; G06F 17/21

(52) U.S. Cl. CPC G06N 3/08; G06F 17/21; G06N 5/04; G06F 16/3329

(57) ABSTRACT

Provided is a method of providing a shared neural model by a question-answering system, the method including: learning a shared neural model on the basis of initial model learning data; providing a plurality of user terminals with the shared neural model upon completing the learning of the shared neural model; upon the user terminal updating the shared neural model to a personalized neural model, collecting the updated personalized neural model; updating the shared neural model on the basis of the collected personalized neural model; and providing the updated shared neural model to the plurality of user terminals.

### CROSS-REFERENCE TO RELATED APPLICATION

This application claims priority to and the benefit of Korean Patent Application No. 2018-0003643, filed on Jan. 11, 2018, and Korean Patent Application No. 2018-0075840, filed on Jun. 29, 2018, the disclosures of which are incorporated herein by reference in its entirety.

### BACKGROUND

### 1. Field of the Invention

The present invention relates to a question-answering system, a cloud server, and a method of providing a shared neural model thereof.

### 2. Discussion of Related Art

A question-answering system is a system designed to, when asked a question to obtain knowledge desired by a user, analyze the question and output an answer related to the question and has been variously implemented so far.

Such a conventional question-answering technology includes machine reading comprehension (MRC) technology.

However, in order to apply the MRC technology to data including private information, the following limitations need to be solved.

First, 100,000 or more pairs of learning data in the form of a ‘question-answer passage’ are needed in general, but it is difficult to collect such a massive amount of learning data in an environment where private information protection is required.

Second, when an MRC learning set is fixed, it is difficult to correctly perform embedding and infer a right answer with respect to coinages which are new words consistently emerging in the real world.

### SUMMARY OF THE INVENTION

The present invention is directed to providing a question answering system, a cloud server, and a method of providing a shared neural model thereof, in which an individual user terminal updates a neural model and a cloud server collects the neural model, generates a shared neural model with the collected neural model, and provides the generated shared neural model to the individual user terminal so that private information regarding personal data is protected while allowing actual usage data of a user to be learned.

The technical objectives of the present invention are not limited to the above, and other objectives may become apparent to those of ordinary skill in the art based on the following descriptions.

According to the first aspect of the present invention, there is provided a question-answering system including: a plurality of user terminals configured to provide text data including private information, answer data corresponding to query data input by a user, and supporting data on the basis of a shared neural model; and a cloud server configured to learn the shared neural model on the basis of initial model learning data and provide the plurality of user terminals with the shared neural model upon completing the learning of the shared neural model.

The initial model learning data may be machine reading comprehension (MRC) model learning data.

The shared neural model may include: a word neural model configured to embed each of the text data and the query data as a vector of a real number dimension; and an answer neural model configured to infer the answer data and the supporting data corresponding to the answer data on the answer data on the basis of a text data vector and a query data vector resulting from the embedding.

The word neural model may embed each of the text data and the query data as the vector of the real number dimension by combining a word-specific embedding vector table with a character and sub-word based neural model.

The user terminal may provide the answer data corresponding to the query data and the supporting data by analyzing the text data on the basis of the shared neural model.

The user terminal may receive feedback from the user by providing the answer data and the supporting data and update the shared neural model to a personalized neural model corresponding to the user terminal on the basis of data fed back from the user.

The user terminal may update the shared neural model to the personalized neural model when the feedback data of a predetermined amount or more of learning is accumulated.

The user terminal may transmit the updated personalized neural model to the cloud server, and the cloud server, upon collecting a predetermined number or more of the personalized neural models from the plurality of user terminals, may update the shared neural model on the basis of the collected personalized neural models and provide the user terminal with the updated shared neural model.

The cloud server may update the shared neural model by calculating an average based on an amount of the feedback data learned by each of the plurality of user terminals and a weight allocated to each of the personalized neural models.

According to the second aspect of the present invention, there is provided a method of providing a shared neural model by a question-answering system, the method including: learning a shared neural model on the basis of initial model learning data; providing a plurality of user terminals with the shared neural model upon completing the learning of the shared neural model; upon the user terminal updating the shared neural model to a personalized neural model, collecting the updated personalized neural model; updating the shared neural model on the basis of the collected personalized neural model; and providing the updated shared neural model to the plurality of user terminals.

The user terminal may provide a user with text data including private information, answer data corresponding to query data input by the user, and supporting data on the basis of the shared neural model.

The user terminal may receive feedback from the user by providing the answer data and the supporting data and update the shared neural model to a personalized neural model corresponding to the user terminal on the basis of data fed back from the user.

The user terminal may update the shared neural model to the personalized neural model when the feedback data of a predetermined amount or more of learning is accumulated.

The method may further include: receiving the updated personalized neural model from the user terminal; upon collecting a predetermined number or more of the personalized neural models from the plurality of user terminal, updating the shared neural model on the basis of the collected personalized neural models; and providing the user terminal with the updated shared neural model.

According to the third aspect of the present invention, there is provided a cloud server for learning and providing a shared neural model, the cloud server including: a communication module configured to transmit and receive data to and from a plurality of user terminals; a memory in which a program for learning and providing a shared neural model is stored; and a processor configured to execute the program stored in the memory, wherein, when the program is executed, the processor may be configured to: learn the shared neural model on the basis of initial model learning data and provide the plurality of user terminals with the learned shared neural model; and, upon the user terminal updating the shared neural model to a personalized neural model, collect the updated personalized neural model, update the shared neural model on the basis of the collected personalized neural model, and provide the plurality of user terminals with the updated shared neural model.

The processor, upon collecting a predetermined number or more of the personalized neural models from the plurality of user terminal, may update the shared neural model on the basis of the collected personalized neural models and provide the user terminal with the updated shared neural model.

The user terminal may provide text data including private information, answer data corresponding to query data input by a user, and supporting data on the basis of the shared neural model.

The user terminal may receive feedback from the user by providing the answer data and the supporting data and update the shared neural model to a personalized neural model corresponding to the user terminal on the basis of data fed back from the user.

### BRIEF DESCRIPTION OF THE DRAWINGS

FIG. 1 is a schematic diagram for describing a question-answering system according to an embodiment of the present invention.

FIG. 2 is a block diagram illustrating a cloud server according to an embodiment of the present invention.

FIG. 3 is a diagram for describing a shared neural model.

FIG. 4 is a flowchart showing a method of providing a shared neural model according to an embodiment of the present invention.

FIG. 5 is a flowchart showing a process of updating a personalized neural model by a user terminal.

### DETAILED DESCRIPTION OF EXEMPLARY EMBODIMENTS

Hereinafter, embodiments of the present invention will be described in detail with reference to the accompanying drawings so that those skilled in the art may easily carry out the present invention. The present invention may be embodied in various ways and is not to be construed as limited to the embodiments set forth herein. In the drawings, parts irrelevant to the description have been omitted for the clarity of explanation, and like numbers refer to like elements throughout the description of the drawings.

The term “comprises,” “includes,” “comprising,” and/or “including” means that one or more other components, steps, and operations and/or the existence or addition of elements may be included in addition to the described components, steps, operation, and/or elements unless context dictates otherwise.

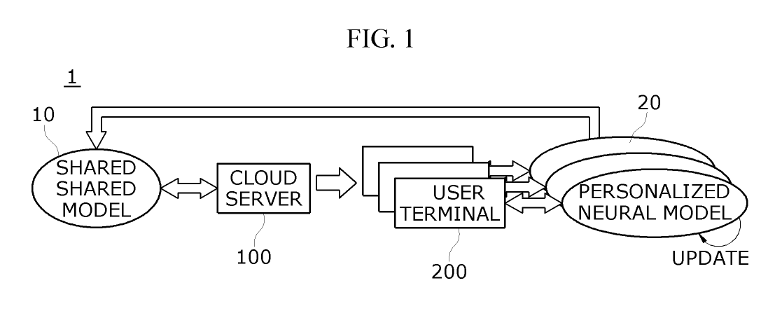

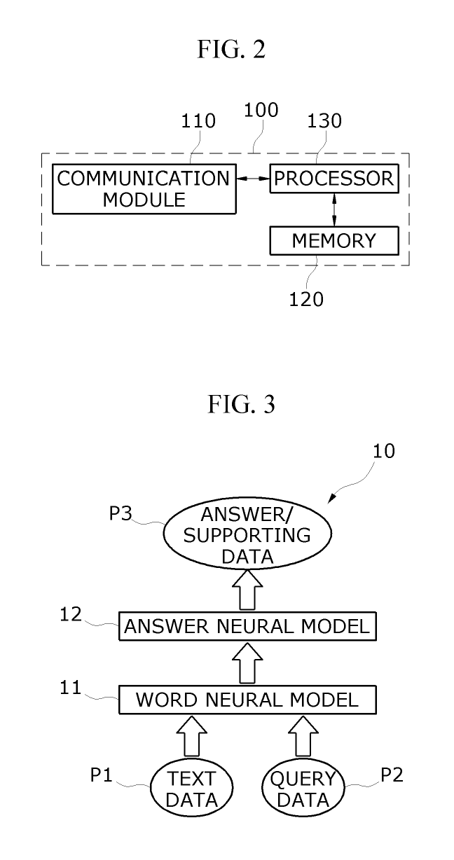

FIG. 1 is a schematic diagram for describing a question-answering system 1 according to an embodiment of the present invention. FIG. 2 is a block diagram illustrating a cloud server 100 according to an embodiment of the present invention. FIG. 3 is a diagram for describing a shared neural model 10.

First, referring to FIG. 1, the question-answering system 1 according to the embodiment of the present invention includes a plurality of user terminals 200 and a cloud server 100.

The plurality of user terminals 200 represent actual usage terminals of users and may be provided in hundreds of thousands to millions of the user terminals 200.

The user terminal 200 receives the shared neural model 10 from the cloud server 100 and analyzes text data including private information to provide a user with answer data corresponding to query data and supporting data on the answer data.

Meanwhile, the user terminal 200 according to the embodiment of the present invention is an intelligent terminal that combines a portable terminal with a computer support function, such as Internet communication and information retrieval, and may include a mobile phone, a smart phone, a pad, a smart watch, a wearable terminal, and other mobile communication terminals in which a plurality of application programs (i.e., applications) desired by a user are installed and executed.

The cloud server 100 is a remote cloud server system and learns the shared neural model 10 and distributes the learned shared neural model 10 to user terminals.

In this case, the cloud server 100 may include a communication module 110, a memory 120, and a processor 130, as shown in FIG. 2.

The communication module 110 transmits and receives data to and from the plurality of user terminals 200. The communication module 110 may include a wired communication module and a wireless communication module. The wired communication module may be implemented with a telephone line communication device, a cable home (MoCA) protocol, an Ethernet protocol, an IEEE1294 protocol, an integrated wired home network, and an RS-485 control device. In addition, the wireless communication module may be implemented with a wireless local area network (WLAN), a Bluetooth protocol, a high-data-rate wireless personal area network (HDR WPAN), an ultra-wideband (UWB) protocol, a ZigBee protocol, an impulse radio protocol, a 60 GHz WPAN, a binary-code division multiple access (CDMA) protocol, wireless Universal Serial Bus (USB) technology, and wireless high-definition multimedia interface (HDMI) technology.

In the memory 120, a program for learning and providing the shared neural model 10 is stored, and the processor 130 executes the program stored in the memory 120.

Here, the memory 120 collectively refers to a nonvolatile storage device, which keeps stored information even when power is not supplied, and a volatile storage device.

For example, the memory 120 may include a NAND flash memory such as a compact flash (CF) card, a secure digital (SD) card, a memory stick, a solid-state drive (SSD), and a micro SD card, a magnetic computer storage device such as a hard disk drive (HDD), and an optical disc drive such as a compact disc read only memory (CD-ROM) and a digital versatile disc (DVD)-ROM.

Referring to FIG. 3, the shared neural model 10 according to the embodiment of the present invention includes a word neural model 11 and an answer neural model 12.

The word neural model 11 embeds each of text data P1 and query data P2 as a vector of a real number dimension. In this case, the word neural model 11 may embed the text data P1 and the query data P2 as a vector of a real number dimension by mixing a word-specific embedding vector table and a character and sub-word based neural model.

Here, the text data P1 refers to data that requires private information protection, such as texting information, e-mail information, and SNS information of the user. The text data P1 may be collected according to a predetermined method by the user terminal and may be input to the shared neural model 10.

In addition, the query data P2 refers to a question of a user provided in the form of natural language. In this case, the user terminal 200 may recognize the question of the user through a keyboard input, a microphone, or the like.

The answer neural model 12 infers answer data P3 and supporting data P4 corresponding to the answer data P3 on the basis of a text data vector and a query data vector according to the embedding of the word neural model 11.

In this case, the answer neural model 12 may be implemented with various algorithms developed by machine reading comprehension (MRC) technology, for example, a bi-directional attention flow (BIDAF) algorithm, a self-attention algorithm, and the like.

Meanwhile, embodiments in which the above-described shared neural model 10 according to the embodiment of the present invention is applied to a short message service (SMS) and e-mail are described as follows.

First, as an example in which the shared neural model 10 is applied to an SMS, an ‘SMS list’ is provided as text data P1 that is input to the shared neural model 10, and a question indicating ‘when is the day to meet with A?’ is provided as query data P2 that is input to the shared neural model 10.

Accordingly, the shared neural model 10 outputs ‘Friday’ as answer data P3 and outputs ‘(Sender A) Then, see you on Friday’ as supporting data P4 corresponding to the answer data P3.

With regard to the answer data P3 and the supporting data P4, the user terminal 200 may collect information indicating correctness of the answer data P3 and the supporting data P4 through a user interaction, such as a ‘CORRECT/INCORRECT button’, and the information indicating correctness may be used as user feedback when updating a personalized neural model 20 at a later time.

As another example in which the shared neural model 10 is applied to an e-mail, ‘e-mail text’ is provided as text data P1 that is input to the shared neural model 10, and a question indicating ‘where is the meeting place today at 10 o'clock?’ is provided as query data P2 that is input to the shared neural model 10.

Accordingly, the shared neural model 10 outputs ‘The 7^{th} research building, conference room No. 462’ as answer data P3 and outputs a statement ‘The meeting will be held on Friday, January 5 at 10 o'clock in the 7^{th} research building, conference room No. 462’ as supporting data P4 corresponding to the answer data P3.

As information indicating correctness of the answer data P3 and the supporting data P4, a user interaction, such as a ‘CORRECT/INCORRECT button’ may be collected.

Hereinafter, a process of learning and distributing the above-described shared neural model 10 by the cloud server 100 will be described in more detail.

The embodiment of the present invention largely includes learning and distributing an initial model, updating a personalized neural model 20, and updating and redistributing a shared neural model.

First, the processor 130 of the cloud server 100 executes the program stored in the memory 120, to thereby learn the shared neural model 10 on the basis of initial model learning data, and upon completing the learning, provides the plurality of user terminals 200 with the shared neural model 10.

In this case, the initial model learning data according to an embodiment of the present invention may be MRC model learning data based on Wikipedia or a news website according to one embodiment of the present invention.

When the shared neural model 10 is provided to the plurality of user terminals 200, the user terminal 200 may analyze text data P1 on the basis of the shared neural model 10 and provide the user with answer data P3 corresponding to query data P2 and supporting data P4.

Then, the user terminal 200 may receive user feedback in response to providing the answer data P3 and the supporting data P4 and update a personalized neural model 20 corresponding to the user terminal 200 with the shared neural model 10 on the basis of such feedback data.

In this case, the user terminal 200 may update the shared neural model 10 to the personalized neural model 20 when a predetermined condition is satisfied.

For example, the user terminal 200 may perform the update upon satisfying at least one of the following conditions: the feedback of a predetermined amount or more of learning is accumulated; the user terminal 200 is being charged; or the user terminal is not used (for example, at night).

Upon completion of the update, the user terminal 200 transmits the updated personalized neural model 20 to the cloud server 100. In this case, in a state of being connected to Wi-Fi, the user terminal 200 may transmit the personalized neural model 20 to the cloud server 100 upon satisfying at least one of the following conditions: the user terminal 200 is being charged or the user terminal 200 is not used.

The processor 130 of the cloud server 100, upon collecting a predetermined number or more of the personalized neural models 20 from the plurality of user terminals 200 through the communication module 110, updates the shared neural model 10 on the basis of the collected personalized neural models 20.

In this case, the processor 130 may update the shared neural model 10 by calculating the average based on the amount of feedback data by the user and used for additional learning in each user terminal 200 and the weight allocated to each of the personalized neural models 20. That is, the processor 130 may update the shared neural model 10 by calculating the weighted average that reflects the number of feedback times of the user as a weight. In addition, it should be readily understood that another update method may be used together with or separately from the above-described update method.

When the update of the shared neural model 10 is completed, the shared neural model 10 is subject to a verification and optimization process in a question-answer data set for evaluation, and, upon completing such a process, the shared neural model 10 is redistributed to the user terminals 200 as a new model.

The elements illustrated in FIGS. 1 to 3 according to the embodiments of the present invention may be implemented in the form of software or hardware, such as a field programmable gate array (FPGA) or an application specific integrated circuit (ASIC), and may perform predetermined functions.

However, the “elements” are not limited to meaning software or hardware. Each of the elements may be configured to be stored in a storage medium capable of being addressed and configured to be executed by one or more processors.

Accordingly, examples of the elements may include elements such as software elements, object-oriented software elements, class elements, and task elements, processes, functions, attributes, procedures, subroutines, segments of a program code, drivers, firmware, microcode, circuits, data, databases, data structures, tables, arrays, and parameters.

Elements and functions provided in the corresponding elements may be combined into fewer elements or may be further divided into additional elements.

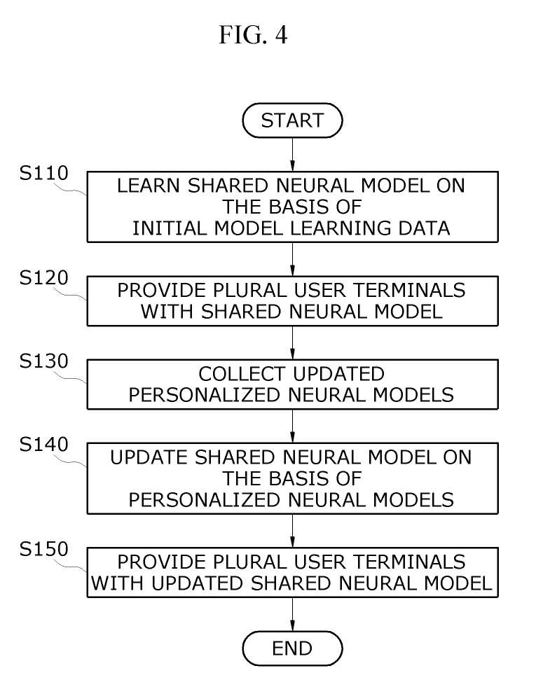

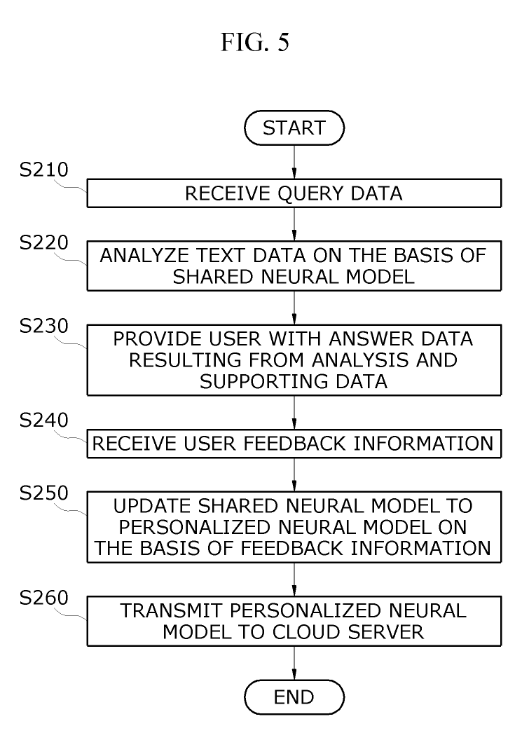

Hereinafter, a method of providing a shared neural model in the question-answering system 1 according to an embodiment of the present invention will be described with reference to FIGS. 4 and 5.

FIG. 4 is a flowchart showing a method of providing a shared neural model according to an embodiment of the present invention. FIG. 5 is a flowchart showing a process of updating the personalized neural model 20 by the user terminal 200.

The method of providing a shared neural model according to the embodiment of the present invention, first, includes learning a shared neural model 10 on the basis of initial model learning data (S110). Upon completion of the learning, the shared neural model 10 is provided to a plurality of user terminals 200 (S120).

Then, updating a personalized neural model 20 is performed by the user terminal 200. In this regard, referring to FIG. 5, the user terminal 200 receives query data P2 (S210), analyzes text data P1 including private information on the basis of the shared neural model 10 (S220), and provides the user with answer data P3 resulting from the analysis and supporting data P4 (S230).

Then, the user terminal 200 receives user feedback regarding the answer data P3 and the supporting data P4 (S240), updates a personalized neural model 20 corresponding to the user terminal 200 with the shared neural model 10 on the basis of the feedback data (S250), and, upon completion of the update, transmits the personalized neural model 20 to the cloud server 100 (S260).

Referring again to FIG. 4, upon the user terminal 200 updating the shared neural model 10 to the personalized neural model 20, the updated personalized neural models 20 are collected from the plurality of user terminals 200 (S130).

The shared neural model 10 is updated on the basis of the collected personalized neural models 20 (S140), and the updated shared neural model 10 is provided to the plurality of user terminals 200 (S150).

The above-described operations S110 to S260 may be further divided into additional operations or may be combined into fewer operations depending on implementation of the present invention. In addition, some of the operations may be omitted if necessary or executed in a reverse order. Descriptions of the question-answering system and the cloud server omitted but having been described above in FIGS. 1 to 3 may be applied to the method of providing a shared neural model shown in FIGS. 4 and 5.

In the conventional method of applying deep learning, despite the need to perform learning on the same environment as an actual usage environment, the conventional centralized data collection and learning has limitation in being applied to a case in which private information protection is needed.

However, the embodiments of the present invention can provide the question-answering system 1 that is personalized by allowing neural model learning to be performed on data and environment that are actually used by each user so that the above-described limitation is removed.

In addition, since the weighting data rather than private information data is transmitted online, private information can be protected.

Although the method and system according to the invention have been described in connection with the specific embodiments of the invention, some or all of the components or operations thereof may be realized using a computer system that has general-use hardware architecture.

As is apparent from the above, the present invention can provide the question-answering system that is personalized by allowing neural model learning to be performed on data and environment that are actually used by each user.

In addition, the present invention can protect private information by transmitting the weighting data rather than private information data.

The above description of the invention is for illustrative purposes, and a person having ordinary skilled in the art should appreciate that other specific modifications can be easily made without departing from the technical spirit or essential features of the invention. Therefore, the above embodiments should be regarded as illustrative rather than limitative in all aspects. For example, components which have been described as being a single unit can be embodied in a distributed form, whereas components which have been described as being distributed can be embodied in a combined form.

The scope of the present invention is not defined by the detailed description as set forth above but by the accompanying claims of the invention. It should also be understood that all changes or modifications derived from the definitions and scope of the claims and their equivalents fall within the scope of the invention.

What is claimed is:

1. A question-answering system comprising:
a plurality of user terminals configured to provide text data including private information, answer data corresponding to query data input by a user, and supporting data on the basis of a shared neural model; and
a cloud server configured to learn the shared neural model on the basis of initial model learning data and provide the plurality of user terminals with the shared neural model upon completing the learning of the shared neural model.

2. The question-answering system of claim 1, wherein the initial model learning data is machine reading comprehension (MRC) model learning data.

3. The question-answering system of claim 1, wherein the shared neural model includes:
a word neural model configured to embed each of the text data and the query data as a vector of a real number dimension; and
an answer neural model configured to infer the answer data and the supporting data corresponding to the answer data on the answer data on the basis of a text data vector and a query data vector resulting from the embedding.

4. The question-answering system of claim 3, wherein the word neural model embeds each of the text data and the query data as the vector of the real number dimension by combining a word-specific embedding vector table with a character and sub-word based neural model.

5. The question-answering system of claim 1, wherein the user terminal provides the answer data corresponding to the query data and the supporting data by analyzing the text data on the basis of the shared neural model.

6. The question-answering system of claim 5, wherein the user terminal receives feedback from the user by providing the answer data and the supporting data and updates the shared neural model to a personalized neural model corresponding to the user terminal on the basis of data fed back from the user.

7. The question-answering system of claim 6, wherein the user terminal updates the shared neural model to the personalized neural model when the feedback data of a predetermined amount or more of learning is accumulated.

8. The question-answering system of claim 6, wherein the user terminal transmits the updated personalized neural model to the cloud server, and
the cloud server, upon collecting a predetermined number or more of the personalized neural models from the plurality of user terminals, updates the shared neural model on the basis of the collected personalized neural models and provides the user terminal with the updated shared neural model.

9. The question-answering system of claim 8, wherein the cloud server updates the shared neural model by calculating an average based on an amount of the feedback data learned by each of the plurality of user terminals and a weight allocated to each of the personalized neural models.

10. A method of providing a shared neural model by a question-answering system, the method comprising:
learning a shared neural model on the basis of initial model learning data;
providing a plurality of user terminals with the shared neural model upon completing the learning of the shared neural model;
upon the user terminal updating the shared neural model to a personalized neural model, collecting the updated personalized neural model;
updating the shared neural model on the basis of the collected personalized neural model; and
providing the updated shared neural model to the plurality of user terminals.

11. The method of claim 10, wherein the user terminal provides a user with text data including private information, answer data corresponding to query data input by the user, and supporting data on the basis of the shared neural model.

12. The method of claim 11, wherein the user terminal receives feedback from the user by providing the answer data and the supporting data and updates the shared neural model to a personalized neural model corresponding to the user terminal on the basis of data fed back from the user.

13. The method of claim 12, wherein the user terminal updates the shared neural model to the personalized neural model when the feedback data of a predetermined amount or more of learning is accumulated.

14. The method of claim 12, further comprising:
receiving the updated personalized neural model from the user terminal;
upon collecting a predetermined number or more of the personalized neural models from the plurality of user terminal, updating the shared neural model on the basis of the collected personalized neural models; and
providing the user terminal with the updated shared neural model.

15. A cloud server for learning and providing a shared neural model, the cloud server comprising:
a communication module configured to transmit and receive data to and from a plurality of user terminals;
a memory in which a program for learning and providing a shared neural model is stored; and
a processor configured to execute the program stored in the memory,
wherein, when the program is executed, the processor is configured to:
learn the shared neural model on the basis of initial model learning data and provide the plurality of user terminals with the learned shared neural model; and
upon the user terminal updating the shared neural model to a personalized neural model, collect the updated personalized neural model, update the shared neural model on the basis of the collected personalized neural model, and provide the plurality of user terminals with the updated shared neural model.

16. The cloud server of claim 15, wherein the processor, upon collecting a predetermined number or more of the personalized neural models from the plurality of user terminal, updates the shared neural model on the basis of the collected personalized neural models and provides the user terminal with the updated shared neural model.

17. The cloud server of claim 15, wherein the user terminal provides text data including private information, answer data corresponding to query data input by a user, and supporting data on the basis of the shared neural model.

18. The cloud server of claim 17, wherein the user terminal receives feedback from the user by providing the answer data and the supporting data and updates the shared neural model to a personalized neural model corresponding to the user terminal on the basis of data fed back from the user.
